(19) United States
(12) Patent Application Publication
(10) Pub. No.: US 2026/0339409 A1
(43) Pub. Date: Oct. 29, 2026

(54) Capacitive Sensing for Device Power Management

(71) Applicant: Advanced Micro Devices, Inc., Santa Clara, CA (US)

(72) Inventors: Subash Puthparambil Maniyath, Chennai (IN); Prashant Kaushal, Bengaluru (IN)

(73) Assignee: Advanced Micro Devices, Inc., Santa Clara, CA (US)

(21) Appl. No.: 19/193,788

(22) Filed: Apr. 29, 2025

(51) Int. Cl. G06F 1/26

(52) U.S. Cl. CPC G06F 1/26

(57) ABSTRACT

Capacitive sensing for device power management is described. In accordance with the described techniques, a device includes one or more capacitive sensors, and a sensor processor communicatively coupled to one or more capacitive sensors. The sensor processor receives a capacitance measurement from the one or more capacitive sensors, and controls power consumption of the device based on whether the capacitance measurement indicates that a human user is handling the device.

### BACKGROUND

Power management is a critical consideration in the design and operation of portable and handheld electronic devices. As devices become more sophisticated and feature-rich, they often require increased computational resources, which can lead to higher power consumption and heat generation. Portable devices and handheld devices, such as laptops, tablets, and smartphones, rely on battery power and have limited cooling capabilities, making efficient power management essential for extending battery life and maintaining user comfort.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system to implement techniques of capacitive sensing for device power management.

FIG. 3 depicts examples illustrating how capacitive sensors are integrated in different types of devices.

FIG. 4 is a block diagram of a non-limiting example system to adjust power based on a capacitance measurement.

FIG. 5 depicts a procedure in an example implementation of capacitive sensing for device power management as implemented by a sensor processor.

FIG. 6 depicts a procedure in an example implementation of capacitive sensing for device power management as implemented by a power management unit.

FIG. 7 depicts a procedure in an example implementation of capacitive sensing for device power management as implemented by a capacitive sensor.

### DETAILED DESCRIPTION

Power consumption and heat dissipation are major concerns for handheld and portable computing devices such as laptops, tablets, and smartphones. One manner of managing power consumption and heat dissipation is by detecting human interaction. This includes reducing power consumption and heat dissipation while a human user is interacting with a device in order to prevent user discomfort from excessive heat dissipation. Conventional techniques rely solely on inertial sensors like accelerometers and gyroscopes to detect whether a device is being handled by a user. However, these methods are indirect and inaccurate manners of detecting human interactions, frequently producing false positives and false negatives.

The techniques described herein address these limitations by implementing a capacitive sensing system for device power management. As part of this, one or more capacitive sensors (e.g., capacitive sensing plates) are integrated within the chassis or housing of a portable or handheld device, and positioned along surfaces associated with human handling or contact. In some implementations, the device also includes inertial sensors (e.g., accelerometer(s), gyroscope(s), and/or magnetometer(s).

A sensor processor receives capacitance measurements from the capacitive sensors and optionally fuses this data with measurements from the inertial sensors. The sensor processor utilizes algorithms to analyze these inputs and determine the device's positional state, indicating whether the device is being handled or contacted by a human user. For example, human handling of the device is detected based on capacitance measurements being within a particular range associated with human proximity to or human contact with the device.

The sensor processor communicates the positional state to a power management unit, which adjusts power consumption for the device based on the positional state. Adjusting the power consumption includes adjusting throttling of (e.g., adjusting clock frequency, voltage, current supplied to) one or more circuits (e.g., a central processing unit (CPU)) of the device, as well as power gating and/or clock gating various circuitry components of the device. If the positional state is indicative of a transition to the device being handled by the human user, then the power management unit reduces power consumption for the device, e.g., increases throttling of the device's CPU. If the positional state is indicative of a transition to the device no longer being handled by the human user, then the power management unit increases power consumption for the device, e.g., reduces throttling of the device's CPU.

The described techniques utilize capacitance for determining whether a device is being handled by a human user, which is a more accurate mechanism for detecting human touch, contact, or proximity than inertial sensor measurements. The described techniques further improve human interaction detection accuracy by combining the capacitance measurements with inertial sensor measurements for analysis. This improved accuracy alleviates instances of excessive heat dissipation while the device is held by or otherwise contacting the user, thereby improving user experience. Furthermore, by reducing false negatives (instances where a human user is inaccurately determined as not handling the device), the system reduces overall power consumption for the device as compared to conventional techniques that fail to reduce power consumption in these scenarios.

In some aspects, the techniques described herein relate to a device including one or more capacitive sensors, and a sensor processor communicatively coupled to the one or more capacitive sensors, the sensor processor configured to receive, from the one or more capacitive sensors, a capacitance measurement, and control, based on whether the capacitance measurement indicates that a human user is handling the device, power consumption of the device.

In some aspects, the techniques described herein relate to a device, wherein the device includes a power management unit, and the sensor processor is configured to control the power consumption by communicating a positional state to the power management unit indicating whether the human user is handling the device, thereby causing the power management unit to adjust the power consumption of the device.

In some aspects, the techniques described herein relate to a device, wherein the sensor processor is configured to initiate a reduction in the power consumption of the device based on the capacitance measurement indicating a transition to the device being handled by the human user.

In some aspects, the techniques described herein relate to a device, wherein the sensor processor is configured to initiate an increase in the power consumption of the device based on the capacitance measurement indicating a transition to the device no longer being handled by the human user.

In some aspects, the techniques described herein relate to a device, wherein the one or more capacitive sensors include at least one capacitive sensing plate integrated within a chassis of the device, and the at least one capacitive sensing plate is positioned along a surface of the device associated with human handling.

In some aspects, the techniques described herein relate to a device, wherein the device is a laptop computer, and the at least one capacitive sensing plate is integrated within a bottom chassis of the laptop computer, and the at least one capacitive sensing plate extends substantially along a bottom surface of the laptop computer.

In some aspects, the techniques described herein relate to a device, wherein the sensor processor is configured to control the power consumption by initiating an adjustment of one or more of a clock frequency, a voltage, or a current supplied to one or more circuits of the device.

In some aspects, the techniques described herein relate to a device, further including one or more inertial sensors including one or more of an accelerometer, a gyroscope, or a magnetometer, wherein the sensor processor is configured to receive one or more sensor measurements from the one or more inertial sensors, detect, based on the capacitance measurement and the one or more sensor measurements, a positional state indicating whether the device is being handled by the human user, and control the power consumption of the device based on whether the device is being handled by the human user.

In some aspects, the techniques described herein relate to a method including receiving, by a power management unit of a device, a positional state indicating whether the device is being handled by a human user, the positional state detected based on a capacitance measurement from one or more capacitive sensors of the device, and adjusting, by the power management unit, power consumption of the device based on the positional state.

In some aspects, the techniques described herein relate to a method, wherein the positional state indicates a transition to the device being handled by the human user, and adjusting the power consumption includes reducing the power consumption of the device.

In some aspects, the techniques described herein relate to a method, wherein the positional state indicates a transition to the device no longer being handled by the human user, and adjusting the power consumption includes increasing the power consumption of the device.

In some aspects, the techniques described herein relate to a method, wherein the one or more capacitive sensors include at least one capacitive sensing plate integrated within a chassis of the device, and the at least one capacitive sensing plate is positioned along a surface of the device associated with human handling.

In some aspects, the techniques described herein relate to a method, wherein the device is a tablet, and the at least one capacitive sensing plate extends substantially along a rear surface of the chassis of the tablet.

In some aspects, the techniques described herein relate to a method, wherein adjusting the power consumption includes adjusting throttling of one or more circuits of the device.

In some aspects, the techniques described herein relate to a method, wherein the device includes one or more inertial sensors including one or more of an accelerometer, a gyroscope, or a magnetometer, and the positional state is further detected based on one or more sensor measurements from the one or more inertial sensors.

In some aspects, the techniques described herein relate to a handheld device including a sensor processor, and a capacitive sensor configured to generate a capacitance measurement, and communicate the capacitance measurement to the sensor processor, thereby causing the sensor processor to initiate a reduction in power consumption of the handheld device based on the capacitance measurement being within a range associated with human handling.

In some aspects, the techniques described herein relate to a handheld device, wherein the capacitance measurement causes the sensor processor to initiate an increase in the power consumption of the handheld device based on the capacitance measurement being outside the range.

In some aspects, the techniques described herein relate to a handheld device, wherein the capacitive sensor is a capacitive sensing plate integrated within a chassis of the handheld device, and positioned along a surface of the handheld device associated with human handling or human contact.

In some aspects, the techniques described herein relate to a handheld device, wherein the handheld device is a smartphone, and the capacitive sensing plate extends substantially along a rear surface of the smartphone.

In some aspects, the techniques described herein relate to a handheld device, wherein the capacitance measurement causes the sensor processor to initiate a reduction of one or more of a clock frequency, a voltage, or a current supplied to one or more circuits of the handheld device.

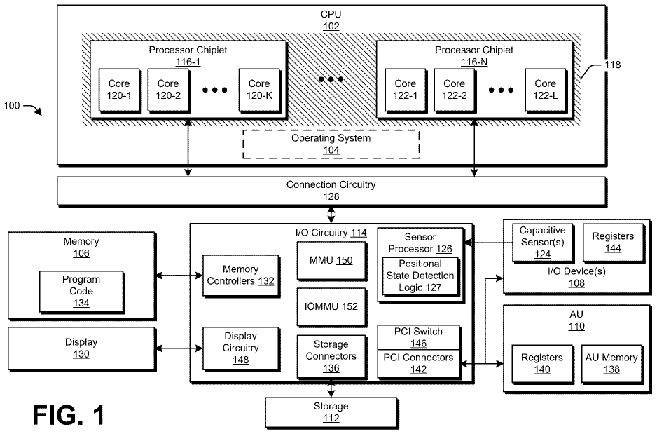

FIG. 1 is a block diagram of a processing system configured to execute one or more applications, in accordance with one or more implementations. Examples of the applications include compute applications (e.g., machine-learning applications, neural network applications, high-performance computing applications, databasing applications, gaming applications), graphics applications, and the like. Examples of devices in which the processing system is implemented include, but are not limited to, a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the operating system 104 is configured to schedule the execution of tasks (e.g., instructions) for applications, allocate portions of resources (e.g., system memory 106, CPU 102, input/output (I/O) device(s) 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In accordance with the described techniques, the I/O devices 108 include one or more capacitive sensors 124. Generally, the capacitive sensors 124 are integrated within a chassis or housing of the device in which the processing system 100 is implemented, and are positioned along a surface of the device associated with human contact and/or handling. In addition, the I/O circuitry is illustrated as including a sensor processor 126, which runs positional state detection logic 127, e.g., firmware and/or software. The sensor processor 126, by running the positional state detection logic 127, is configured to analyze capacitance measurements from the capacitive sensors 124 to detect a positional state indicating whether the device in which the processing system 100 is implemented is being handled or contacted by a human user. Further, based on the positional state, the sensor processor 126 initiates power and thermal control operations to control heat dissipation and power consumption of the device.

In this example, the sensor processor 126 and positional state detection logic 127 are depicted in the I/O circuitry. In variations, however, the sensor processor 126 and/or positional state detection logic 127 are included in and/or implemented by one or more different components of the processing system 100, such as the CPU 102, the memory 106, the I/O device 108, the AU 110, the storage 112, the I/O circuitry 114, and so forth. In at least one implementation, the sensor processor 126 and positional state detection logic 127 or portions of the sensor processor 126 and positional state detection logic 127 are included in at least two of the depicted components of the processing system 100.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the operating system 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

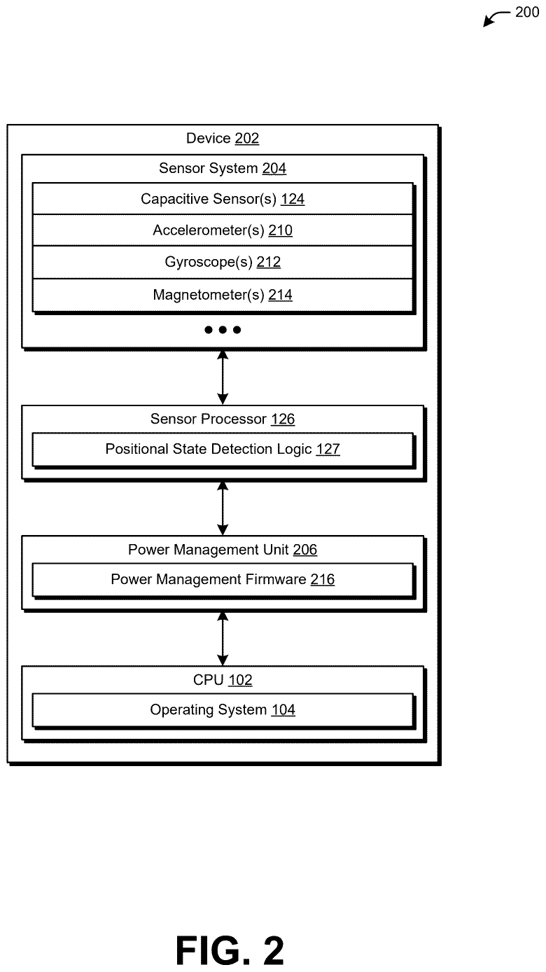

FIG. 2 is a block diagram of a non-limiting example system to implement techniques of capacitive sensing for device power management. The system 200 includes a device 202 having a sensor system 204, the sensor processor 126, a power management unit 206, and the CPU 102. The sensor system 204, the sensor processor 126, the power management unit 206, and the CPU 102 are interconnected (e.g., communicatively coupled) via one or more wired and/or wireless connections. Example wired connections include, but are not limited to, buses, (e.g., a data bus), interconnects, traces, and planes.

Generally, the device 202 is a portable device that is handled physically by a human user during operation. In various examples, the device 202 is a handheld device. Examples of handheld devices include, but are not limited to, laptop computers, notebook computers, smartphones, wireless phones, tablets, phablets, convertible tablet-laptop hybrids, e-readers, portable gaming consoles, gaming controllers, digital cameras, handheld medical devices, handheld scientific instruments, and handheld smart power tools.

As shown, the device 202 includes a sensor system 204, which includes a plurality of sensors. Generally, sensors are devices (e.g., implemented in circuitry) that receive a stimulus regarding a measured property, and converts that stimulus to an electrical signal. More specifically, the sensor system 204 includes one or more capacitive sensors 124, which detect changes in capacitance. Generally, a capacitive sensor 124 works by measuring how an object (e.g., a conductive or dielectric material) affects an electric field surrounding conductive plate(s). For example, a capacitive sensor 124 is formed by two conductive plates separated by a dielectric material, or a capacitive sensor 124 includes just one capacitive sensing plate. When a dielectric or conductive material approaches or touches the capacitive sensor 124 the effective permittivity of the system changes. The capacitive sensor 124 measures capacitance based on this change in effective permittivity.

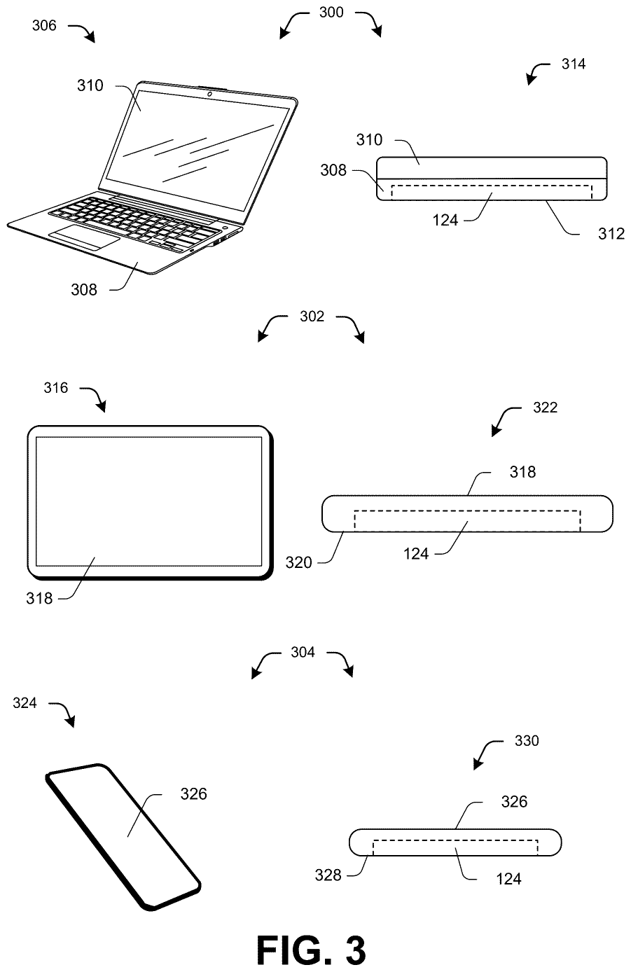

Capacitive sensors 124 are particularly suitable for detecting human touch and/or human proximity. This is because the human body is conductive and exhibits unique conductivity and dielectric properties. In some examples, the capacitive sensors 124 utilize multi-frequency sensing, time-based filtering, and pattern recognition to differentiate between gradual, consistent capacitance changes from a human body, and sudden, irregular capacitance changes from non-conductive objects or random interference. Additionally or alternatively, the capacitive sensors 124 analyze signal strength, contact area, and response behaviors to ignore false triggers from water or other unintended objects while accurately detecting human interaction. In accordance with the described techniques, the capacitive sensors 124 are integrated within a chassis of the device 202 along a surface of the device 202 associated with human contact and/or human handling, as further discussed below with reference to FIG. 3.

The sensor system 204 further includes inertial sensors, examples of which include but are not limited to accelerometer(s) 210, gyroscope(s) 212, and magnetometer(s) 214. Generally, inertial sensors measure the acceleration, vibration, angular velocity, and/or orientation of a body, e.g., the device 202. In particular, accelerometers 210 measure linear acceleration forces in one or more axes, gyroscopes 212 measure orientation and angular velocity, and magnetometers 214 measure the strength and direction of magnetic fields, including Earth's magnetic field. It is to be appreciated that the sensor system 204 includes additional sensor types without departing from the spirit or scope of the described techniques.

In one or more implementations, the inertial sensors are integrated in a micro-electro-mechanical system (MEMS) chip that includes mechanical components and electrical components. For example, the MEMS chip includes the accelerometer(s) 210, gyroscope(s) 212, and magnetometer(s) 214, and a microprocessor to receive and process sensor data (e.g., electrical signals) from the various inertial sensors. To facilitate property sensing by the various inertial sensors, the MEMS chip includes microscopic moving parts, like suspended masses, suspension beams, and vibrating masses. It is noted, however, that while the inertial sensors are integrated in the MEMS chip, the capacitive sensor(s) 124 are separate from the MEMS chip.

The sensor processor 126 is an electronic circuit that is configured to receive and process sensor data from the sensor system 204. As shown, the sensor processor 126 includes positional state detection logic 127, which is representative of software and/or firmware running on the sensor processor 126. In accordance with the described techniques, the positional state detection logic 127 receives sensor data from the sensor system 204. Further, the positional state detection logic 127 processes the sensor data to detect a positional state of the device 202, which indicates whether the device 202 is being handled and/or physically contacted by a human user. In this sense, the sensor processor 126 and/or the positional state detection logic 127 are representative of a sensor fusion system configured to process information from various different sensors to detect the positional state of the device 202.

In one example, the detection of the positional state is based on a capacitance measurement from the capacitive sensor(s) 124, such as whether the capacitance measured by the capacitive sensor(s) 124 is within a range associated with human proximity and/or human contact. Additionally or alternatively, the detection of the positional state is based on sensor data from the inertial sensors, indicating an orientation and vibration of the device 202. For instance, the positional state is detected based on whether the orientation indicates that the device is on a flat surface (e.g., a table), and whether a vibration signature of the device 202 corresponds with human handling.

The power management unit 206 is an electronic circuit (e.g., a processor or a controller) configured to perform operations related to power management of the device 202. To carry out such operations, the power management unit 206 includes power management firmware 216 (e.g., power management firmware), which is representative of executable code or software instructions embedded within (e.g., stored in non-volatile memory of) the power management unit 206. Broadly, the power management unit (by running the power management firmware 216) is configured to control power states, adjust voltages and current delivery, and manage clock frequencies for circuitry components of the device 202 such as the CPU 102 (and cores thereof), the AU 110, and the memory 106.

In accordance with the described techniques, the power management unit 206 receives an indication of the positional state of the device 202 from the sensor processor 126, and adjusts power consumption of the device 202 based on the positional state. As part of the power consumption adjustment process, the power management unit 206 requests permission from the operating system 104 to adjust the power consumption of the device 202. This is done because the operating system 104 has a broader view of system resources, running processes, and user preferences, ensuring that power adjustments are made in a coordinated manner that maintains system stability and performance while optimizing energy efficiency. If the operating system 104 grants permission, then the power management unit 206 adjusts the power consumption of the device 202 accordingly.

When the positional state indicates a transition to the device 202 being handled by a human user, the power management unit 206 reduces the power consumption of the device 202. In contrast, when the positional state indicates a transition to the device 202 no longer being handled by the human user, the power management unit 206 increases the power consumption of the device. Notably, adjusting (e.g., reducing or increasing) the power consumption includes, by way of example and not limitation, adjusting (e.g., reducing or increasing) throttling, clock frequency, voltage, and/or current supplied to one or more circuitry components of the device 202, e.g., the CPU 102, the AU 110, and/or the memory 106. By reducing the power consumption of the device 202 when the device 202 is being handled by the human user, the system 200 reduces heat dissipation and potential user discomfort while the device 202 is being held, handled, or otherwise contacted by the human user.

Conventional techniques for human interaction driven power management rely solely on inertial sensors for determining whether a device is being handled by a human. Due to this, current solutions for detecting human interaction for power management are inaccurate, frequently producing false negatives and false positives. This is, in part, because the inertial sensors rely on microscopic mechanical components. As such, the measurements from these sensors are highly dependent on temperature, potentially giving false data when exposed to different temperatures.

In contrast, the described techniques utilize capacitance for determining whether a device is being handled by a human user, which is a more accurate mechanism for detecting human touch, contact, or proximity than device orientation or vibration. Moreover, since the capacitive sensor(s) 124 do not rely on microscopic mechanical components, the capacitive measurement is significantly less dependent on temperature. While the inertial sensors, by themselves, are an inaccurate mechanism for detecting human handling, they do provide evidence of human handling. Thus, by combining the sensor data from the inertial sensors with the capacitance measurements, the described techniques further improve human interaction detection accuracy (as compared to capacitance alone).

This improved accuracy alleviates instances of excessive heat dissipation while the device 202 is being held by the user, thereby improving user experience as compared to conventional techniques. Furthermore, by reducing false negatives (instances where a human user is inaccurately determined as not handling the device), the system 200 reduces overall power consumption for the device 202 as compared to conventional techniques that fail to reduce power consumption in these scenarios.

FIG. 3 depicts examples 300, 302, 304 illustrating how capacitive sensors are integrated in different types of devices. In particular, a first example 300 illustrates how a capacitive sensor 124 is integrated within a laptop computer in accordance with the described techniques. As shown in the three-dimensional view 306 of the laptop computer, the laptop computer has a bottom chassis 308 and a top chassis 310. Generally, a chassis is the structural framework or enclosure that supports and houses the internal components of an electronic device, providing physical protection and serving as a mounting platform for various hardware elements. The bottom chassis 308 includes a top surface (e.g., having a keyboard and touchpad), and a bottom surface 312 opposite the top surface. The bottom surface 312 generally rests on an external surface (e.g., a table or a user's lap) when the laptop computer is in use. As shown in a front view 314 of the laptop computer (e.g., illustrated in the closed position), the capacitive sensor(s) 124 are formed as at least one capacitive sensing plate integrated within the bottom chassis 308 of the laptop computer, and extending substantially along the bottom surface 312.

A second example 302 illustrates how a capacitive sensor 124 is integrated within a tablet computer in accordance with the described techniques. As shown in a top view 316 of the tablet computer, the tablet computer includes a front surface 318 with a display screen. Further, a rear surface 320 of the tablet computer is opposite the front surface 318. The rear surface 320 is generally contacted by a human user (e.g., the rear surface 320 is generally held by the human user or rests on the human user's lap) while the tablet is in use. As shown in the side view 322, the capacitive sensor(s) 124 are formed as at least one capacitive sensing plate integrated within a chassis of the tablet computer, and extending substantially along the rear surface 320.

A third example 304 illustrates how a capacitive sensor 124 is integrated within a smartphone in accordance with the described techniques. As shown in a three-dimensional view 324 of the smartphone, the smartphone includes a front surface 326 with a display screen. Further, a rear surface 328 is opposite the front surface 326, and the rear surface 328 is generally contacted by a human user (e.g., the rear surface 328 is held by a human user) while the smartphone is in use. As shown in a side view 330 of the smartphone, the capacitive sensor(s) 124 are formed as at least one capacitive sensing plate integrated within a chassis of the smartphone, and extending substantially along the rear surface 328.

In summary, regardless of the device 202 type, the capacitive sensor(s) 124 are integrated within a chassis of the device 202, and the capacitive sensor(s) 124 are capacitive sensing plates positioned along a surface of the device 202 associated with human contact and/or human handling. The examples 300, 302, 304 depicted and described above are not to be construed as limiting. Rather, the capacitive sensor(s) 124 are integrated similarly within any handheld or portable device without departing from the spirit or scope of the described techniques. In one example, for instance, the device 202 is a handheld device with a handle, such as a medical instrument, or a smart power tool. In this example, the capacitive sensor(s) 124 are integrated within a housing or chassis of the handle, with the capacitive sensing plate being positioned along a surface of the handle. In some instances, the handle is cylindrical or semi-cylindrical, and the capacitive sensing plates are made from flexible, bendable materials to enable positioning of the capacitive sensor(s) 124 around a surface of the handle.

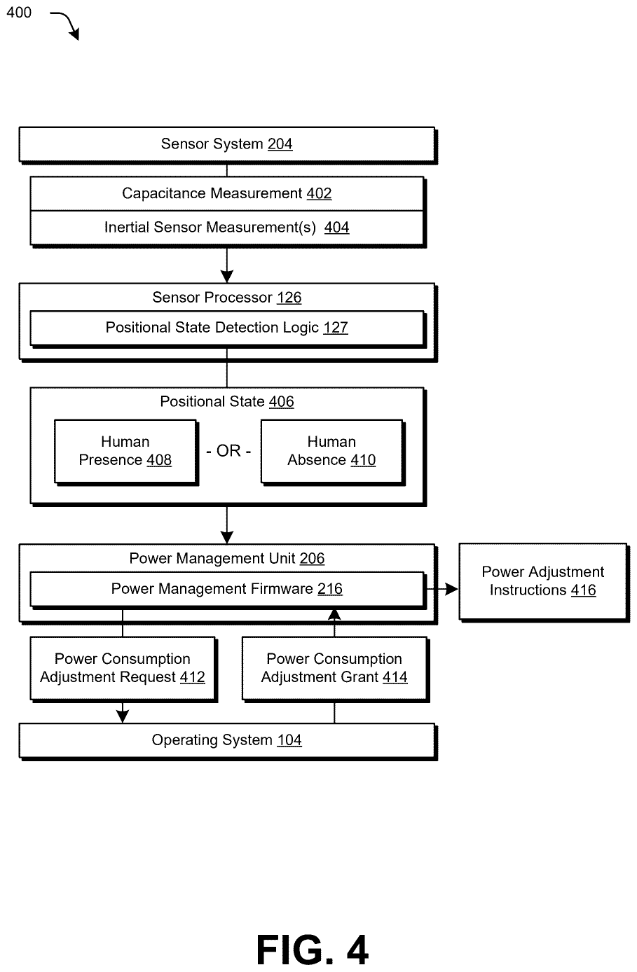

FIG. 4 is a block diagram of a non-limiting example system 400 to adjust power based on a capacitance measurement. In accordance with the described techniques, the capacitive sensor(s) 124 of the sensor system 204 generate a capacitance measurement 402. Moreover, one or more inertial sensors of the sensor system 204 (e.g., the accelerometer(s) 210, the gyroscope(s) 212, the magnetometer(s) 214) generate inertial sensor measurement(s) 404. As shown, the capacitance measurement 402 and the inertial sensor measurement(s) 404 are communicated to the sensor processor 126.

Generally, the positional state detection logic 127 is configured to process the capacitance measurement 402, and optionally, the inertial sensor measurement(s) 404 to detect a positional state 406 of the device 202. In variations, the positional state 406 indicates a human presence 408 (e.g., that the device is being handled by a human user), or a human absence 410, e.g., that the device is not being handled by a human user. In some instances, the human presence 408 is a positional state that the device 202 is in the user's hand(s) or on the user's lap, while the human absence is a positional state the device 202 is on a table or some other (non-human) surface.

To detect the positional state 406, the positional state detection logic 127 analyzes the capacitance measurement 402. For example, the positional state detection logic 127 is programmed with a range of capacitance values associated with human contact, proximity, and/or handling. Further, the positional state detection logic 127 detects the human presence 408 as the positional state 406 based on the capacitance measurement 402 being within the range of capacitance values. In contrast, the positional state detection logic 127 detects the human absence 410 as the positional state 406 based on the capacitance measurement 402 being outside the range of capacitance values.

The sensor processor 126 and/or the positional state detection logic 127 employ various alternative capacitance analysis techniques to detect human contact and/or proximity in some implementations. One approach involves utilizing multi-frequency sensing, in which the capacitive sensor 124 emits signals at different frequencies, and the capacitance measurement 402 includes the response patterns at these different frequencies. Here, the positional state detection logic 127 analyzes these response patterns, and compares them to expected response patterns from human tissue since human tissue exhibits unique frequency-dependent characteristics.

Another approach is to analyze the consistency and duration of capacitance changes. This is because human interactions tend to produce more stable and prolonged capacitance changes, whereas objects like water droplets or metal debris cause sudden or irregular spikes. Here, the positional state detection logic 127 may detect whether the device is being handled by the human by analyzing how the capacitance changes over time, and whether the changing capacitance correlates with human contact or human handling. Additionally or alternatively, the positional state detection logic 127 implements pattern recognition algorithms to identify specific capacitance change signatures associated with human touch or proximity.

In some implementations, the sensor processor 126 and/or the positional state detection logic 127 further analyze the inertial sensor measurements 404 to detect the positional state 406. As further discussed above, the inertial sensor measurements 404 are indicative of orientation and vibration of the device 202. For example, the positional state detection logic 127 uses the orientation of the device 202 to determine whether the device is positioned flat on a surface. If the device 202 is positioned flat on a surface, human handling is less likely, and a probability of the human presence 408 is reduced. Contrarily, sudden orientation changes and or movement characteristics like natural tilting, shaking, or lifting of the device 202 can increase the probability of the human presence 408.

The positional state detection logic 127 further uses the vibration of the device 202 to detect whether human proximity or human contact is present. Notably, human handling produces distinct vibration patterns from hand tremors, and subtle shifts, tilts, and grip adjustments that occur when the user interact with the device 202. In some instances, the positional state detection logic 127 compares the vibration level of the device 202 to a vibration threshold. If the vibration level exceeds the vibration threshold, then the probability of the human presence 408 is increased, and vice versa. In some implementations, a more complex vibration analysis algorithm is implemented to determine whether the vibration pattern exhibited by the device 202 is consistent with human contact and/or handling.

As shown, the positional state 406 is communicated to the power management unit 206. Based on the positional state 406 indicating a transition (e.g., from the human absence 410 to the human presence 408, or from the human presence 408 to the human absence 410), the power management firmware 216 communicates a power consumption adjustment request 412 to the operating system 104. Depending on the direction of the transition, the request 412 is to reduce or increase the power consumption of the device 202, as further discussed below. The operating system 104 evaluates the current system state, including active processes, resource utilization, and user-defined power settings, to determine whether to grant the power consumption adjustment request 412, ensuring that any changes align with overall system performance requirements and user preferences. Here, the operating system 104 issues a power consumption adjustment grant 414, allowing the power management unit 206 to adjust the power of one or more circuitry components of the device 202.

Upon being granted access to adjust the power consumption of the device 202, the power management unit 206 and/or firmware 216 sends power adjustment instructions 416 to one or more circuitry components of the device 202. Generally, the power adjustment instructions adjust (e.g., reduce or increase) the power supplied to the one or more circuitry components. Examples of power adjustment include adjusting throttling, clock frequency, voltage, and/or current supplied to the one or more circuitry components of the device 202. Additionally or alternatively, power adjustment includes enabling or disabling clock gating or power gating to the one or more circuitry components. Notably, clock gating disables the clock signal to the one or more circuitry components, while power gating disables the power supply entirely to the one or more circuitry components.

In one or more implementations, the positional state 406 indicates a transition to the device 202 being handled by the human user, e.g., a transition from the human absence 410 to the human presence 408. Here, the power consumption adjustment request 412 and the power adjustment instructions 416 are to reduce the power consumption for the device 202, thereby reducing heat dissipation. For example, the power adjustment instructions 416 increase throttling of the CPU 102 in response to the transition to the device 202 being handled by the human user.

In some implementations, the positional state 406 indicates a transition to the device 202 no longer being handled by the human user, e.g., a transition from the human presence 408 to the human presence 408. Here, the power consumption adjustment request 412 and the power adjustment instructions 416 are to increase the power consumption for the device 202. For example, the power adjustment instructions 416 to reduce throttling of the CPU 102 in response to the transition to the device 202 no longer being handled by the human user.

In various examples, the described techniques support waking the device 202 from a deep sleep state when the human presence 408 is detected. In this scenario, even while in a low-power mode, the capacitive sensors 124 remain active, continuously monitoring for significant changes in capacitance that indicate human proximity or contact. When the capacitance measurement 402 crosses a predetermined threshold associated with human presence, it triggers an interrupt signal to the power management unit 206. This signal initiates a wake-up sequence, transitioning the device 202 from its deep sleep state to an active state. As the device 202 powers on, it may gradually activate various components and services. This feature enhances user experience by providing instant accessibility without requiring physical button presses, while also conserving battery life by maintaining minimal power consumption during periods of inactivity.

Additionally or alternatively, the system 400 implements mode-aware power management policies by detecting specific high performance usage modes (e.g., gaming, video editing, virtual reality and/or augmented reality, and live streaming), and adjusting power management strategies accordingly. For instance, when the device 202 enters a gaming mode, detected through factors like the launch of a game application, specific GPU utilization patterns, or user-defined settings, the power management unit 206 overrides its default power-saving behaviors. In gaming mode, the system prioritizes performance over power efficiency, maintaining full CPU and GPU clock speeds, disabling throttling, and ensuring maximum available power to all relevant components. This mode-aware approach prevents power reduction (and unwanted performance drops) during gameplay, even if the positional state detection logic 127 detects that the device 202 is being handled. When the gaming session ends, detected through app closure or a shift in resource utilization patterns, the system can revert to its standard power management policies.

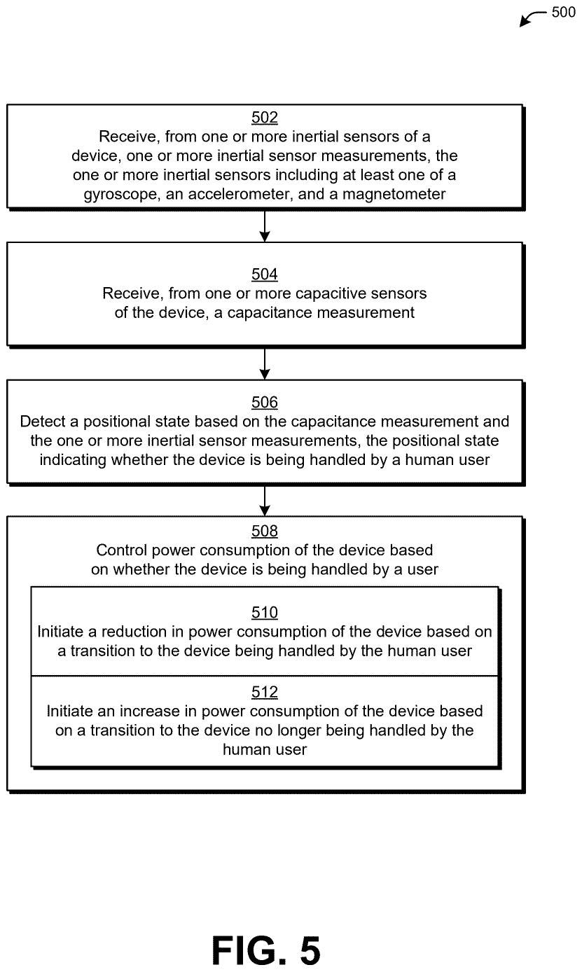

FIG. 5 depicts a procedure 500 in an example implementation of capacitive sensing for device power management as implemented by a sensor processor. In the procedure 500, one or more inertial sensor measurements are received from one or more inertial sensors including at least one of a gyroscope, an accelerometer, and a magnetometer (block 502). By way of example, the sensor processor 126 receives the inertial sensor measurement(s) 404 from the inertial sensors, e.g., the accelerometer(s) 210, the gyroscope(s) 212, and/or the magnetometer(s) 214. The inertial sensor measurement(s) 404 are indicative of device 202 orientation and vibration.

A capacitance measurement is received from one or more capacitive sensors of the device (block 504). For example, the sensor processor 126 receives the capacitance measurement 402 from the capacitive sensor(s) 124. The capacitive sensor(s) 124 are integrated within a chassis of the device 202, and positioned along a surface of the device 202 associated with human contact and/or human handling, e.g., a bottom surface of a laptop or a rear surface of a smartphone or tablet.

A positional state is detected based on the capacitance measurement and the one or more inertial sensor measurements, and the positional state indicates whether the device is being handled by a human user (block 506). For instance, the sensor processor 126 (by running the positional state detection logic 127) analyzes the capacitance measurement 402 and the inertial sensor measurement(s) 404 to detect a positional state 406 of the device 202. The positional state 406 indicates a human presence 408 (e.g., the device 202 is being handled by a human user) or a human absence 410 (e.g., the device 202 is not being handled by a human user).

Power consumption of the device is controlled based on whether the device is being handled by the human user (block 508). As part of this, a reduction in power consumption of the device is initiated based on a transition to the device being handled by the human user (block 510), and an increase in power consumption of the device is initiated based on a transition to the device no longer being handled by the human user (block 512). For example, the sensor processor 126 communicates the positional state 406 to the power management unit 206, causing the power management unit 206 to adjust power consumption of the device 202 based on the positional state 406. If the positional state 406 indicates a transition to the device 202 being handled by the human user (e.g., a transition from the human absence 410 to the human presence 408), the power management unit 206 increases throttling of (e.g., reduces the clock frequency, voltage, and/or current supplied to) one or more circuits of the device 202. If, however, the positional state 406 indicates a transition to the device 202 no longer being handled by the human user (e.g., a transition from the human presence 408 to the human absence 410), then the power management unit 206 reduces throttling of (e.g., increases the clock frequency, voltage, and/or current supplied to) the one or more circuits of the device 202.

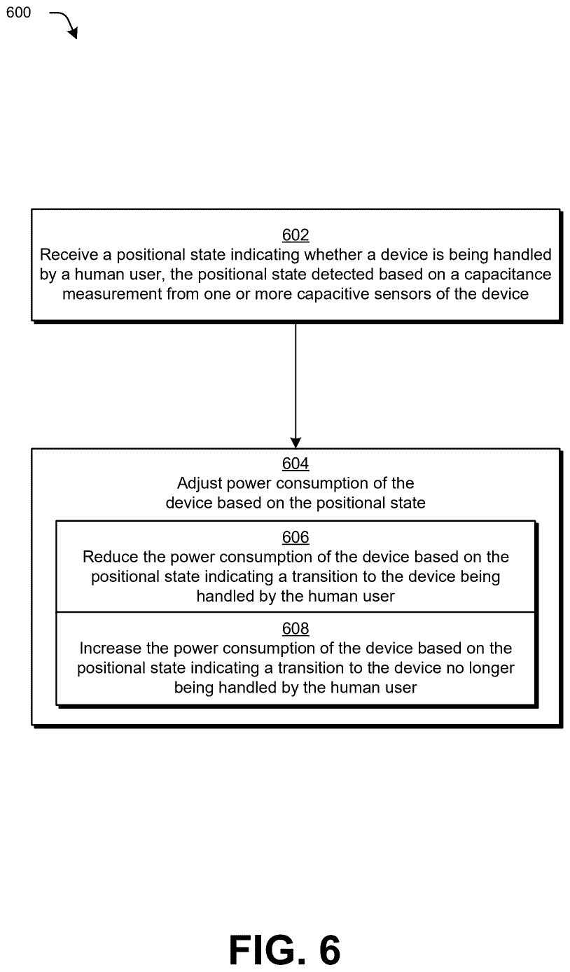

FIG. 6 depicts a procedure 600 in an example implementation of capacitive sensing for device power management as implemented by a power management unit. In the procedure 600, a positional state is received indicating whether a device is being handled by a human user, and the positional state is detected based on a capacitance measurement from one or more capacitive sensors of the device (block 602). By way of example, the power management unit 206 receives a positional state 406 from the sensor processor 126 indicating whether the device is being handled, contacted, or held by a human user. The positional state 406 is detected by the sensor processor 126 based, in part, on a capacitance measurement 402 from one or more capacitive sensors 124 of the device 202. The capacitive sensors 124 are integrated within a chassis or housing of the device 202, and positioned along a surface of the device associated with human handling or human contact.

Power consumption of the device is adjusted based on the positional state (block 604). As part of this, the power consumption is reduced based on the positional state indicating a transition to the device being handled by the human user (block 606), and the power consumption is increased based on the positional state indicating a transition to the device no longer being handled by the human user (block 608). For example, if the positional state 406 indicates a transition to the device 202 being handled by the human user (e.g., a transition from the human absence 410 to the human presence 408), the power management unit 206 increases throttling of (e.g., reduces the clock frequency, voltage, and/or current supplied to) one or more circuits of the device 202. If, however, the positional state 406 indicates a transition to the device 202 no longer being handled by the human user (e.g., a transition from the human presence 408 to the human absence 410), then the power management unit reduces throttling of (e.g., increases the clock frequency, voltage, and/or current supplied to) the one or more circuits of the device 202.

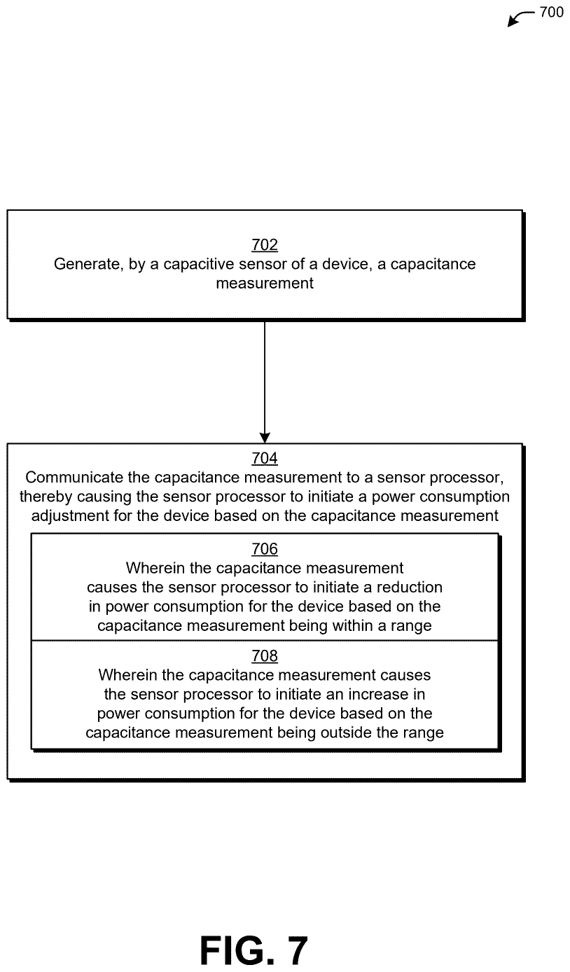

FIG. 7 depicts a procedure 700 in an example implementation of capacitive sensing for device power management as implemented by a capacitive sensor. In the procedure 700, a capacitance measurement is generated by a capacitive sensor of a device (block 702). By way of example, the capacitive sensor 124 generates a capacitance measurement. The capacitive sensor 124 is integrated within a chassis or housing of the device 202, and positioned along a surface of the device 202 associated with human handling or human contact.

The capacitance measurement is communicated to a sensor processor, thereby causing the sensor processor to initiate a power consumption adjustment for the device, based on the capacitance measurement (block 704). As part of this, the capacitance measurement causes the sensor processor to initiate a reduction in power consumption for the device based on the capacitance measurement being within a range (block 706), and the capacitance measurement causes the sensor processor to initiate an increase in power consumption for the device based on the capacitance measurement being outside the range (block 708). For example, the capacitive sensor 124 communicates the capacitance measurement 402 to the sensor processor 126, which analyzes the capacitance measurement 402 to determine whether the capacitance measurement 402 is within a range associated with human proximity, contact, or handling. If the capacitance measurement 402 is within the range, then the sensor processor 126 communicates the positional state 406 indicative of the human presence 408 to the power management unit 206, which increases throttling of (e.g., reduces the clock frequency, voltage, and/or current supplied to) one or more circuits of the device 202. If, however, the capacitance measurement 402 is outside the range, then the sensor processor 126 communicates the positional state 406 indicative of the human absence 410 to the power management unit 206, which reduces throttling of (e.g., increases the clock frequency, voltage, and/or current supplied to) one or more circuits of the device 202.

What is claimed is:

1. A device comprising:
one or more capacitive sensors; and
a sensor processor communicatively coupled to the one or more capacitive sensors, the sensor processor configured to:
receive, from the one or more capacitive sensors, a capacitance measurement; and
control, based on whether the capacitance measurement indicates that a human user is handling the device, power consumption of the device.

2. The device of claim 1, wherein the device includes a power management unit, and the sensor processor is configured to control the power consumption by communicating a positional state to the power management unit indicating whether the human user is handling the device, thereby causing the power management unit to adjust the power consumption of the device.

3. The device of claim 1, wherein the sensor processor is configured to initiate a reduction in the power consumption of the device based on the capacitance measurement indicating a transition to the device being handled by the human user.

4. The device of claim 1, wherein the sensor processor is configured to initiate an increase in the power consumption of the device based on the capacitance measurement indicating a transition to the device no longer being handled by the human user.

5. The device of claim 1, wherein the one or more capacitive sensors include at least one capacitive sensing plate integrated within a chassis of the device, and the at least one capacitive sensing plate is positioned along a surface of the device associated with human handling.

6. The device of claim 5, wherein the device is a laptop computer, and the at least one capacitive sensing plate is integrated within a bottom chassis of the laptop computer, and the at least one capacitive sensing plate extends substantially along a bottom surface of the laptop computer.

7. The device of claim 1, wherein the sensor processor is configured to control the power consumption by initiating an adjustment of one or more of a clock frequency, a voltage, or a current supplied to one or more circuits of the device.

8. The device of claim 1, further comprising one or more inertial sensors including one or more of an accelerometer, a gyroscope, or a magnetometer, wherein the sensor processor is configured to:
receive one or more sensor measurements from the one or more inertial sensors;
detect, based on the capacitance measurement and the one or more sensor measurements, a positional state indicating whether the device is being handled by the human user; and
control the power consumption of the device based on whether the device is being handled by the human user.

9. A method comprising:
receiving, by a power management unit of a device, a positional state indicating whether the device is being handled by a human user, the positional state detected based on a capacitance measurement from one or more capacitive sensors of the device; and
adjusting, by the power management unit, power consumption of the device based on the positional state.

10. The method of claim 9, wherein the positional state indicates a transition to the device being handled by the human user, and adjusting the power consumption includes reducing the power consumption of the device.

11. The method of claim 9, wherein the positional state indicates a transition to the device no longer being handled by the human user, and adjusting the power consumption includes increasing the power consumption of the device.

12. The method of claim 9, wherein the one or more capacitive sensors include at least one capacitive sensing plate integrated within a chassis of the device, and the at least one capacitive sensing plate is positioned along a surface of the device associated with human handling.

13. The method of claim 12, wherein the device is a tablet, and the at least one capacitive sensing plate extends substantially along a rear surface of the chassis of the tablet.

14. The method of claim 9, wherein adjusting the power consumption includes adjusting throttling of one or more circuits of the device.

15. The method of claim 9, wherein the device includes one or more inertial sensors including one or more of an accelerometer, a gyroscope, or a magnetometer, and the positional state is further detected based on one or more sensor measurements from the one or more inertial sensors.

16. A handheld device comprising:
a sensor processor; and
a capacitive sensor configured to:
generate a capacitance measurement; and
communicate the capacitance measurement to the sensor processor, thereby causing the sensor processor to initiate a reduction in power consumption of the handheld device based on the capacitance measurement being within a range associated with human handling.

17. The handheld device of claim 16, wherein the capacitance measurement causes the sensor processor to initiate an increase in the power consumption of the handheld device based on the capacitance measurement being outside the range.

18. The handheld device of claim 16, wherein the capacitive sensor is a capacitive sensing plate integrated within a chassis of the handheld device, and positioned along a surface of the handheld device associated with human handling or human contact.

19. The handheld device of claim 18, wherein the handheld device is a smartphone, and the capacitive sensing plate extends substantially along a rear surface of the smartphone.

20. The handheld device of claim 16, wherein the capacitance measurement causes the sensor processor to initiate a reduction of one or more of a clock frequency, a voltage, or a current supplied to one or more circuits of the handheld device.
